(19) United States
(12) Patent Application Publication
(10) Pub. No.: US 2007/0080740 A1
(43) Pub. Date: Apr. 12, 2007

(54) Reference circuit for providing a temperature independent reference voltage and current

(76) Inventors: Michael T. Berens, Austin, TX (US); James R. Feddeler, Austin, TX (US); Dale J. McQuirk, Austin, TX (US)

Correspondence Address: FREESCALE SEMICONDUCTOR, INC.;LAW DEPARTMENT, 7700 WEST PARMER LANE MD:TX32/PL02, AUSTIN, TX, 78729, US

(21) Appl. No.: 11/244,515

(22) Filed: Oct. 6, 2005

(51) Int. Cl. G05F 1/10

(52) U.S. Cl. 327/539

(57) ABSTRACT

A reference circuit provides a reference voltage and a reference current that are both temperature and a power supply voltage independent. The reference circuit includes a bandgap reference circuit, a current source, and a resistor. The bandgap reference circuit provides a feedback voltage to control the current source and thereby generate a temperature independent voltage and a PTAT (proportional to absolute temperature) current. A resistor having a positive temperature coefficient is coupled to the feedback controlled current source to provide a CTAT (complementary to absolute temperature) current. The CTAT current is summed directly into the feedback controlled current source to produce a reference current that is substantially constant over a range of temperatures.

### FIELD OF THE INVENTION

This invention relates generally to circuits and more specifically to a reference circuit for providing a temperature independent reference voltage and a temperature independent current.

### BACKGROUND

Many electronic circuit applications require a reference voltage and current that are stable with respect to changes in temperature and power supply voltage. Bandgap references are commonly used in integrated circuits to provide a temperature and power supply stable reference voltage. However, the typical bandgap reference circuit provides a current that is proportional to absolute temperature (PTAT). A current that is independent of temperature may be provided by using a resistor having a very low temperature coefficient (TC). However, in a present day CMOS (complementary metal-oxide semiconductor) process it is very difficult to form a resistor with a low enough TC. Therefore, to provide an independent current on an integrated circuit (IC) a first current is generated having a positive TC and a second current is generated having a negative TC. The first and second currents are then summed and the sum of the currents is substantially temperature independent.

FIG. 1 illustrates, in schematic diagram form, a prior art reference circuit 10 for providing a temperature independent voltage and current. Reference circuit 10 includes a voltage reference circuit 12, voltage reference circuit 14, and P-channel transistors 16 and 18. voltage reference circuit 12 includes mirror circuit 20, P-channel transistor 32, resistor 34, and diode 36. Mirror circuit 20 includes P-channel transistors 22 and 24 and N-channel transistors 26 and 28. Voltage reference circuit 14 includes P-channel transistor 38, operational amplifier 40, and resistor 42.

Generally, in operation, voltage reference circuit 12 generates a temperature independent reference voltage labeled “VREF”. Mirror circuit 20 generates a current through resistor 30 that is mirrored through transistor 32 and resistor 34 to generate a reference voltage labeled “VREF”. Resistors 30 and 34 both have positive temperature coefficients. Diode 36 has a negative TC to cancel the positive TC of resistor 34 and may be implemented as a diode connected bipolar transistor. Reference voltage VREF is equal to the voltage across resistor 34 plus the base-emitter voltage labeled “VBE” and is constant with respect to temperature. The current through resistor 30 is also mirrored through P-channel transistor 16 to produce a current through transistor 16 that is proportional to temperature.

Voltage reference circuit 14 provides a current through P-channel transistor 18 that is complementary to absolute temperature (CTAT). Operational amplifier 40 compares the voltage VBE to a voltage across resistor 42 to adjust a bias voltage at the gate of transistor 38 so that the voltage across resistor 42 is equal to VBE. The voltage forced across resistor 42 by operational amplifier 40 has a negative TC. The negative TC voltage produces a negative TC current through resistor 42. The resulting CTAT current through transistor 18 is summed with the PTAT current to produce current IREF. The transistor ratios and temperature coefficients are adjusted so that current IREF is independent of temperature.

Reference circuit 10 requires two separate current references to produce a temperature stable current. Also, the two current references require careful transistor sizing and matched resistors. In addition, because two separate current references are used, reference circuit 10 has a relatively large number of components.

Therefore, it is desirable to provide a reference circuit that is temperature and supply voltage and current independent in a way that is simple, small, and introduces very few sources for error.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates identical items unless otherwise noted.

FIG. 1 illustrates, in schematic diagram form, a voltage and current reference circuit in accordance with the prior art.

FIG. 2 illustrates, in partial schematic diagram form and partial block diagram form, an embodiment of a voltage and current reference circuit in accordance with one embodiment of the present invention.

FIG. 3 illustrates, in schematic diagram form, a voltage and current reference circuit in accordance with another embodiment of the present invention.

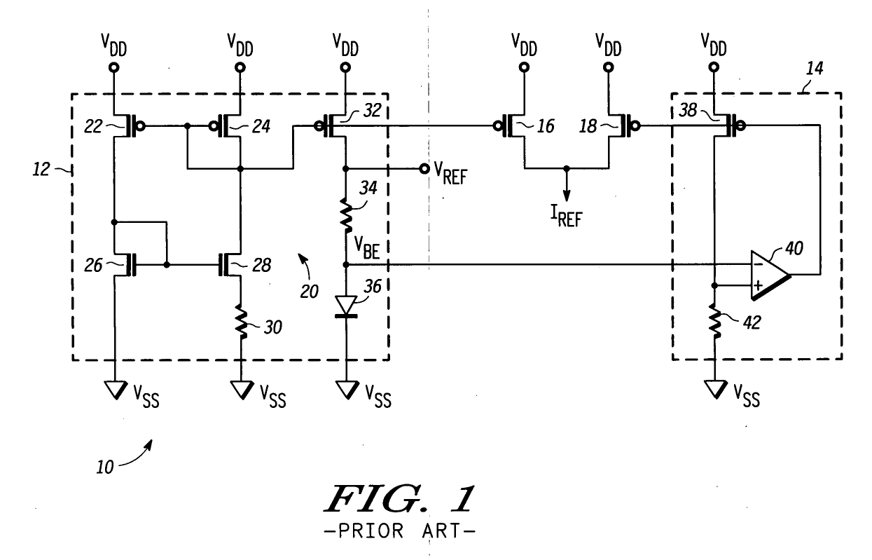

### DETAILED DESCRIPTION

Generally, the present invention provides, in one embodiment, a reference circuit for providing a reference voltage and a reference current that are both temperature and a power supply voltage independent. The reference circuit includes a bandgap reference circuit, a current source, and a resistor. The bandgap reference circuit provides a feedback voltage to control the current source and thereby generate a temperature independent voltage and a PTAT (proportional to absolute temperature) current. A resistor having a positive temperature coefficient is coupled to the feedback controlled current source to provide a CTAT (complementary to absolute temperature) current. The CTAT current is summed directly into the feedback controlled current source to produce a reference current that is substantially constant over a range of temperatures. The reference circuit provides the advantage of having only a single resistor to provide the CTAT current. Also, by adding only a single resistor, only resistor matching is necessary to produce a temperature independent current.

The following sets forth a detailed description of a mode for carrying out the invention. The description is intended to be illustrative of the invention and should not be taken to be limiting.

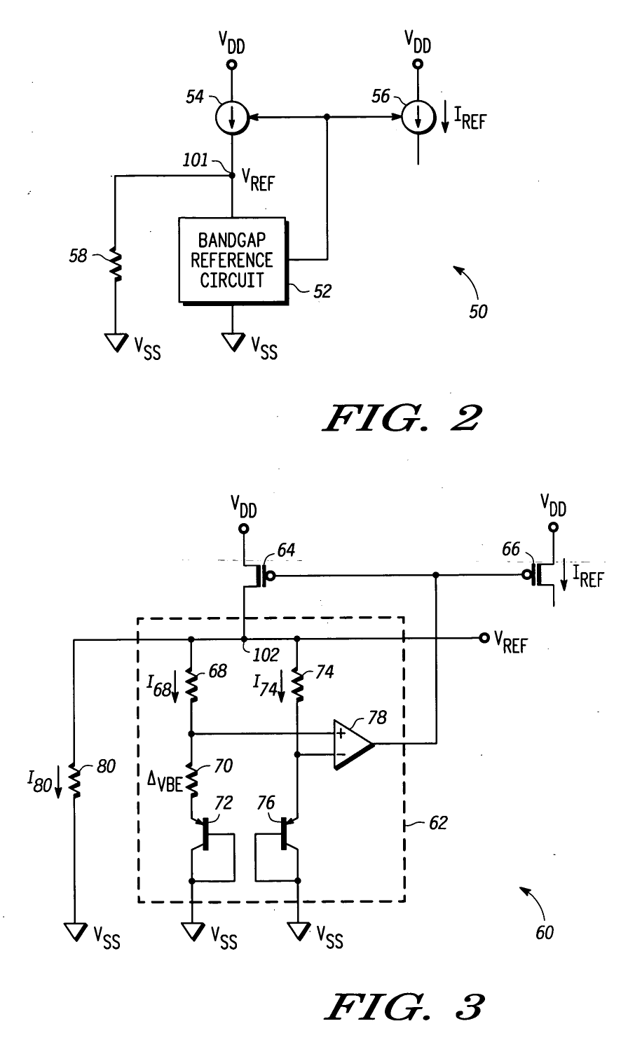

FIG. 2 illustrates, in partial schematic diagram form and partial block diagram form, a voltage and current reference circuit 50 in accordance with one embodiment of the present invention. Reference circuit 50 includes a bandgap reference circuit 52, current sources 54 and 56, and a resistor 58. Current source 54 has a first terminal coupled to a power supply voltage terminal labeled “VDD”, a second terminal coupled to a node 101 for providing a reference voltage labeled “VREF”, and a control terminal. Current source 56 has a first terminal coupled to VDD, a second terminal for providing a temperature independent current labeled “IREF”, and a control terminal coupled to the control terminal of current source 54. Bandgap reference circuit 52 has a first terminal coupled to the second terminal of current source 54 at node 101, a second terminal coupled to a power supply voltage terminal labeled “VSS”, and a third terminal coupled to the control terminals of current sources 54 and 56. A resistor 58 has a first terminal coupled to current source 54 at node 101, and a second terminal coupled to VSS.

In operation, the bandgap reference circuit 52 generates a temperature independent reference voltage VREF at node 101 based on the bandgap voltage of silicon. A current provided by current source 54 is controlled by feedback from the bandgap reference circuit 52. A PTAT current is generated by having one or more components in bandgap reference circuit 52 with- a positive TC. A CTAT current is generated through resistor 58 by implementing resistor 58 to have a positive TC. A conventional CMOS (complementary metal-oxide semiconductor) integrated circuit manufacturing process may produce a resistor having a predetermined positive TC or predetermined negative TC. In the illustrated embodiment, the only requirement is that the resistor have a TC that is positive and less than kT/q, where k is Boltzmann's constant, T is temperature, and q is charge. A suitable resistor may be, for example, one of either a P-poly resistor, an N-well resistor, an N-diffusion resistor, an N-poly resistor, or a P-diffusion resistor. The CTAT current is summed directly into the feedback controlled current source 54 with the PTAT current to produce a temperature independent current. The current through current source 54 is mirrored by current source 56 to generate temperature independent current IREF. Note that current IREF may be substantially equal to the current through current source 54 or different depending on the current mirror ratio between current sources 54 and 56.

FIG. 3 illustrates, in schematic diagram form, a voltage and current reference circuit 60 in accordance with another embodiment of the present invention. Reference circuit 60 includes a bandgap reference circuit 62, transistors 64 and 66, and a resistor 80. Bandgap reference circuit 62 includes resistors 68, 70, and 74, diode-connected transistors 72 and 76, and operational amplifier 78.

Transistor 64 has a first current electrode coupled to power supply voltage terminal VDD, a control electrode, and a second current electrode coupled to a node 102. Transistor 66 has a first current electrode coupled to VDD, a control electrode coupled to the control electrode of transistor 64, and a second current electrode for providing a current IREF. In the illustrated embodiment, transistors 64 and 66 are implemented as P-channel MOS transistors. Resistor 68 has a first terminal coupled to the second current electrode of transistor 64, and a second terminal. Resistor 74 has a first terminal coupled to the second current electrode of transistor 64, and a second terminal. Resistor 70 has a first terminal coupled to the second terminal of resistor 68, and a second terminal. Transistor 72 has a first current electrode coupled to the second terminal of resistor 70, and a control electrode and a second current electrode coupled to power supply voltage terminal VSS. Transistor 76 has a first current electrode coupled to the second terminal of resistor 74, and a control electrode and a second current electrode coupled to VSS. In the illustrated embodiment, transistors 72 and 76 are implemented as diode-connected bipolar transistors. Operational amplifier 78 has a negative input terminal coupled to the second terminal of resistor 68, a positive input terminal coupled to the second terminal of resistor 74, and an output terminal coupled to the control electrodes of transistors 64 and 66. In the illustrated embodiment, operational amplifier 78 is implemented as a single-stage differential pair with a current mirror load. In other embodiments, operational amplifier 78 may be another operational amplifier type. Resistor 80 has a first terminal coupled to the second current electrode of transistor 64 at node 102, and a second terminal coupled to VSS.

In operation, bandgap reference circuit 62 provides a temperature independent voltage labled VREF and a PTAT current at node 102. Resistor 80 provides a CTAT current at node 102. The positive temperature coefficient of the PTAT current is canceled by the negative temperature coefficient of the CTAT current to generate a temperature independent current IREF. The PTAT current at node 102 is produce by summing a current through resistor 68 labled “I68” with a current through resistor 74 labeled “174”. Resistors 68 and 74 both have the same resistance values and positive temperature coefficients so that 168 equals I74. Note that in other embodiments, the resistance values of resistors 68 and 74 may be different. The positive temperature coefficient causes the current through resistors 68 and 74 to increase proportionally with increasing temperature. The positive temperature coefficients of resistors 68 and 74 are canceled by negative temperature coefficients of the base-emitter voltages of transistors 72 and 76, respectively, to provide a temperature independent voltage VREF at node 102. A voltage across resistor 70 is a difference in the base-emitter voltages of transistors 72 and 76 labeled “DeltaVBE”. Operational amplifier 78 forces the voltages at its input terminals to be equal to each other by adjusting the bias voltage of transistors 64 and 66 via a feedback signal to the control electrodes of transistors 64 and 66.

Resistor 80 has a positive TC and provides a negative CTAT current that decreases proportionally with increasing temperature. The negative TC of current 180 is selected to compensate for, or cancel, the positive temperature coefficients of currents 168 and 174 to produce a reference current IREF that is substantially constant over a range of temperatures. In the illustrated embodiment, the range of temperature is from -40 degrees Celsius to +125 degrees Celsius.

Bandgap reference circuit 62 is one example of a bandgap reference circuit that can be used in the reference circuit 52 of FIG. 2. In other embodiments, other bandgap reference circuits can be used. Also, in other embodiments, depending of the type of bandgap reference circuit used, the bandgap reference circuit may produce a CTAT current instead of the illustrated PTAT current. In this case, the resistor 80 would be implemented to have a negative TC creating a PTAT current to cancel the CTAT current.

The reference circuits 50 and 60 may be used in applications that require a temperature independent reference current, such as for example, an oscillator circuit, controlled timer, or a phase-locked loop. Such an application (not shown) can be coupled to the second current electrode of transistor 66.

The use of reference circuits 50 and 60 provide the advantage of having only a single resistor to provide the CTAT current, thus resulting in a small and relatively simple reference circuit for providing a temperature independent current. The use of a single resistor provides the added advantage of requiring only matched resistors.

While the invention has been described in the context of a preferred embodiment, it will be apparent to those skilled in the art that the present invention may be modified in numerous ways and may assume many embodiments other than that specifically set out and described above. For example, the conductivity types of the transistors may be reversed. Accordingly, it is intended by the appended claims to cover all modifications of the invention which fall within the true scope of the invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A reference circuit comprising:
a first current source having a first terminal coupled to a first power supply voltage terminal, a control terminal, and a second terminal for providing a temperature independent reference voltage;
a second current source having a first terminal coupled to the first power supply voltage terminal, a second terminal for providing a temperature independent reference current, and a control terminal;
a bandgap reference circuit comprising a first resistor having a first terminal coupled to the second terminal of the first current source, and a second terminal;
a second resistor having a first terminal coupled to the second terminal of the first current source, and a second terminal;
a third resistor having a first terminal coupled to the second terminal of the first resistor, and a second terminal;
a first transistor having a first current electrode coupled to the second terminal of the third resistor, a control electrode and a second current electrode both coupled to the second power supply voltage terminal;
a second transistor having a first current electrode coupled to the second terminal of the second transistor, a control electrode and a second current electrode both coupled to the second power supply voltage terminal; and
an amplifier having a first input terminal coupled to the second terminal of the first resistor a second input terminal coupled to the second terminal of the second resistor, and an output terminal coupled to the control terminals of both of the first and second current sources; and
a fourth resistor having a first terminal directly connected to the second terminal of the first current source, and a second terminal directly connected to the second power supply voltage terminal.

2. (canceled)

3. The reference circuit of claim 2, wherein the first and second transistors are diode-connected bipolar transistors.

4. The reference circuit of claim 2, wherein the first and second resistors both have a positive temperature coefficient.

5. The reference circuit of claim 2, wherein the first and second resistors both have substantially equal resistance values.

6. The reference circuit of claim 2, wherein the amplifier is an operational amplifier.

7. The reference circuit of claim 1, wherein the bandgap reference circuit provides a first current to the first current source having a positive temperature coefficient, and the resistor provides a second current to the first current source having a negative temperature coefficient.

8. The reference circuit of claim 1, wherein the first and second current sources each comprise a P-channel transistor.

9. The reference circuit of claim 1, wherein the resistor is one of either a P-poly resistor, an N-well resistor, an N-diffusion resistor, an N-poly resistor, or a P-diffusion resistor.

10. A reference circuit comprising:
a first current source having a first terminal coupled to a power supply voltage and a second terminal;
a second current source having a first terminal coupled to the first power supply voltage terminal, a second terminal for providing a temperature independent reference current, and a control terminal;
a bandgap voltage reference circuit coupled to the second terminal of the current source, the bandgap voltage reference circuit for providing a first current having a positive temperature coefficient, the bandgap voltage reference circuit comprising:
a first resistor having a first terminal coupled to the second terminal of the first current source, and a second terminal;
a second resistor having a first terminal coupled to the second terminal of the first current source, and a second terminal;
a third resistor having a first terminal coupled to the second terminal of the first resistor, and a second terminal;
a first transistor having a first current electrode coupled to the second terminal of the third resistor, a control electrode and a second current electrode both coupled to the second power supply voltage terminal;
a second transistor having a first current electrode coupled to the second terminal of the second transistor, a control electrode and a second current electrode both coupled to the second power supply voltage terminal; and
an amplifier having a first input terminal coupled to the second terminal of the first resistor, a second input terminal coupled to the second terminal of the second resistor, and an output terminal coupled to the control terminals of both the first and second current sources; and
a fourth resistor having a first terminal directly connected to the second terminal of the first current source, and a second terminal directly connected to the second power supply voltage terminal, the resistor having a positive temperature coefficient for providing a second current having a negative temperature coefficient;
wherein the first and second currents are combined by the current source to provide a reference current that is substantially constant over a range of temperatures, and wherein a temperature independent voltage is provided at the second terminal of the first current source.

11. (canceled)

12. The reference circuit of claim 10, wherein the resistor is one of either a P-poly resistor, an N-well resistor, an N-diffusion resistor, an N-poly resistor, or a P-diffusion resistor.

13. (canceled)

14. The reference circuit of claim 14, wherein the first and second transistors are diode-connected bipolar transistors.

15. The reference circuit of claim 14, wherein the first and second resistors both have a positive temperature coefficient.

16. The reference circuit of claim 14, wherein the first and second resistors both have substantially equal resistance values.

17. The reference circuit of claim 14, wherein the amplifier is an operational amplifier.

18. (canceled)

19. The reference circuit of claim 10, wherein the first, second and third resistors all have positive temperature coefficients.
